(19) United States
(12) Patent Application Publication
(10) Pub. No.: US 2015/0122692 A1
(43) Pub. Date: May 7, 2015

(54) Blister Card

(71) Applicant: Vimal Kavuru, East Burnswick, NJ (US)

(72) Inventor: Vimal Kavuru, East Burnswick, NJ (US)

(21) Appl. No.: 14/280,836

(22) Filed: May 19, 2014

Related U.S. Application Data
(60) Provisional application No. 61/900,174, filed on Nov. 5, 2013.

(51) Int. Cl. A61J 1/03; B65D 25/20

(52) U.S. Cl. CPC A61J 1/035; B65D 25/205
USPC 206/530

(57) ABSTRACT

A blister card for providing an effective pharmacy label location that does not conceal important information or block removal of pill. The blister card generally includes a support member having a pill area for storing a pharmaceutical pill, a label area for receiving a pharmaceutical label and an information area for providing information about the pharmaceutical pill. The label area does not overlap the location of the pharmaceutical pill within the support member to allow for extraction of the pill without damaging of the pharmacy label.

### CROSS REFERENCE TO RELATED APPLICATIONS

I hereby claim benefit under Title 35, United States Code, Section 119(e) of U.S. provisional patent application Ser. No. 61/900,174 filed Nov. 5, 2013. The 61/900,174 application is currently pending. The 61/900,174 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a blister pack and more specifically it relates to a blister card for providing an effective pharmacy label location that does not conceal important information or block removal of pill.

2. Description of the Related Art

Any discussion of the related art throughout the specification should in no way be considered as an admission that such related art is widely known or forms part of common general knowledge in the field.

Blister packs have been in use for years to dispense pharmaceutical pills (e.g. tablets, caplets, capsules, lozenges and the like) that are taken by a patient and various other types of items. The blister packs are typically comprised of a plastic layer that defines a pocket and a backing material (e.g. foil) attached to the plastic layer to retain the item within the pocket. The user presses upon the pocket thereby forcing the item such as a pill outwardly through the backing material by breaking the backing material.

Recently, combination pharmacy label blister packs have been developed wherein the backing material includes an area to affix pharmacy labels to thereby assisting patients taking their medicine. This is particularly useful for blister packs that are for packaging a limited number of pharmacy pills such as one or two pills. For example, Fluconazole is a medication used to treat yeast infections and typically only requires one pill.

One type of combination pharmacy label blister pack is manufactured by Greenstone LLC in Peapack, N.J. for dispensing a single pill of Fluconazole called a “150 mg Tablet Blister Pack Carton” wherein the plastic layer covers the entire front thereof and a layer of foil is attached to the plastic layer defining an area on the rear surface for the pharmacy label to be attached which covers the pocket. One problem with combination pharmacy label blister packs is that the pharmacy label location is positioned on the rear portion of the blister pack making it difficult for a patient to locate and read. Another problem with combination pharmacy label blister packs is that the pharmacy label when applied to the foil covers the exit location for the pill and therefore the pharmacy label is damaged when the user extracts the pill through the foil (and correspondingly through the pharmacy label) thereby making it difficult for the user to read the pharmacy label. Another problem with combination pharmacy label blister packs is that extracting the pill is difficult since the label is attached to the exit location within the foil thereby making it increasingly difficult to force the pill out through the foil.

Because of the inherent problems with the related art, there is a need for a new and improved blister card for providing an effective pharmacy label location that does not conceal important information or block removal of pharmaceutical pill.

### BRIEF SUMMARY OF THE INVENTION

The invention generally relates to a blister card which includes a support member having a pill area for storing a pharmaceutical pill, a label area for receiving a pharmaceutical label and an information area for providing information about the pharmaceutical pill. The label area does not overlap the location of the pharmaceutical pill within the support member to allow for extraction of the pill without damaging of the pharmacy label.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention with a pharmacy label in an exploded perspective with respect to the support member.

FIG. 2 is an upper perspective view of the present invention with the pharmacy label attached to the label area of the support member.

FIG. 3 is a front view of the present invention.

FIG. 4 is a front view of the present invention with the pharmacy label attached to the support member.

FIG. 5 is a cross sectional view taken along line 5-5 of FIG. 4.

FIG. 6 is a cross sectional view taken along line 6-6 of FIG. 4.

FIG. 7a is a rear view of the present invention.

FIG. 7b is a rear view of the present invention with the peel tab removed and the pharmaceutical pill partially extracted through the backing

FIG. 8a is a right side view of the present invention with a pharmacy label attached to the label area.

FIG. 8b is a right side view of the present invention with the peel tab removed and the pharmaceutical pill partially extracted.

FIG. 9 is an exploded right side view of the present invention illustrating the multiple layers for the support member.

FIG. 10 is an exploded upper perspective view of the present invention.

FIG. 11 is a left side view of the present invention with a pharmacy label attached to the label area.

FIG. 12 is a bottom view of the present invention.

FIG. 13 is a top view of the present invention.

### DETAILED DESCRIPTION OF THE INVENTION

### A. Overview.

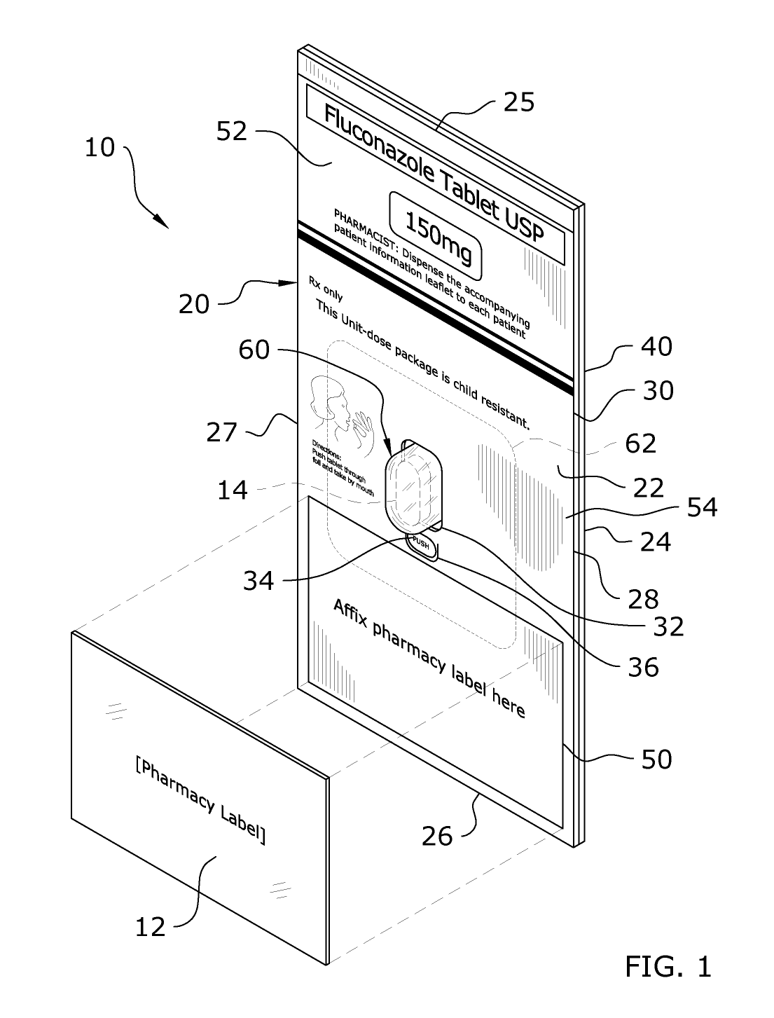

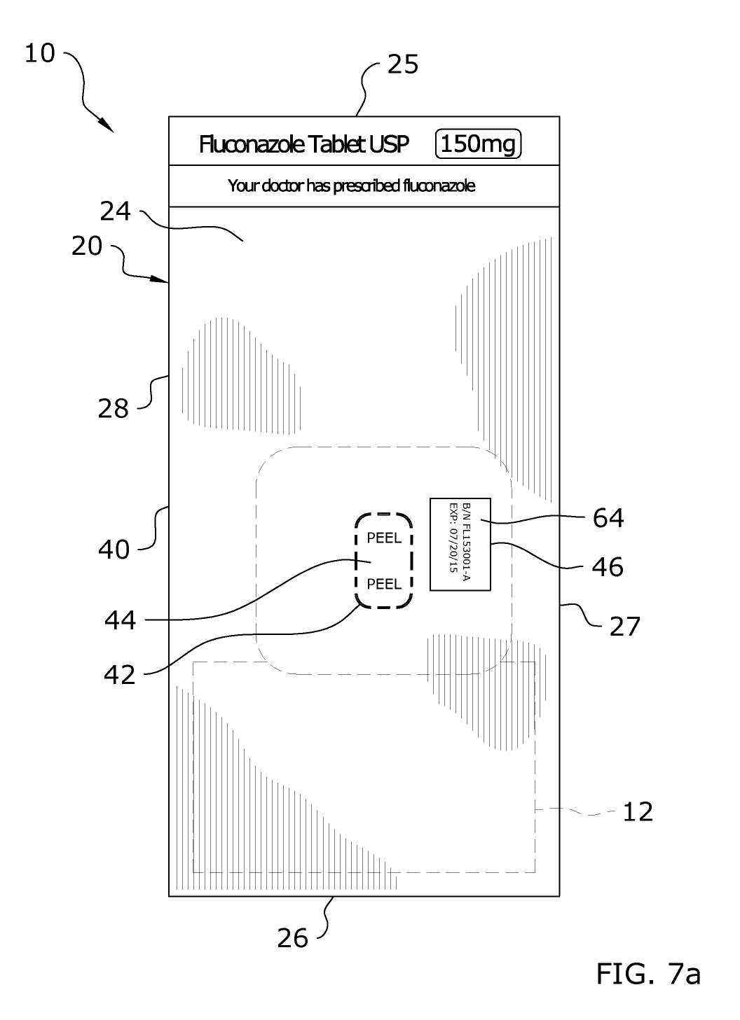

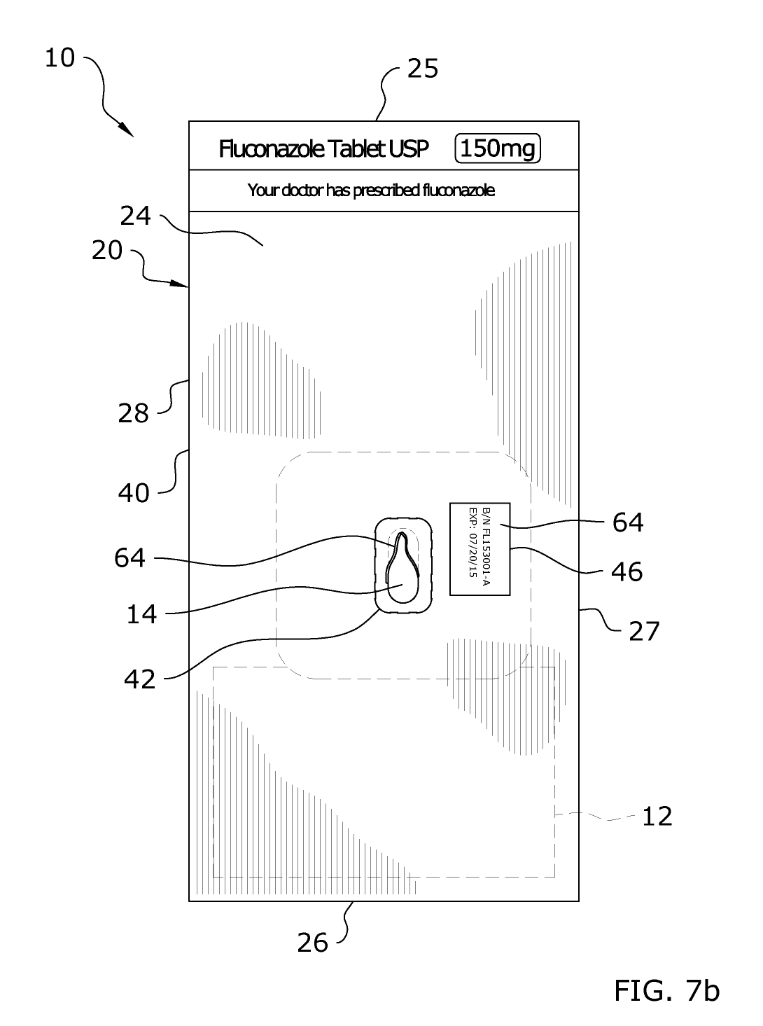

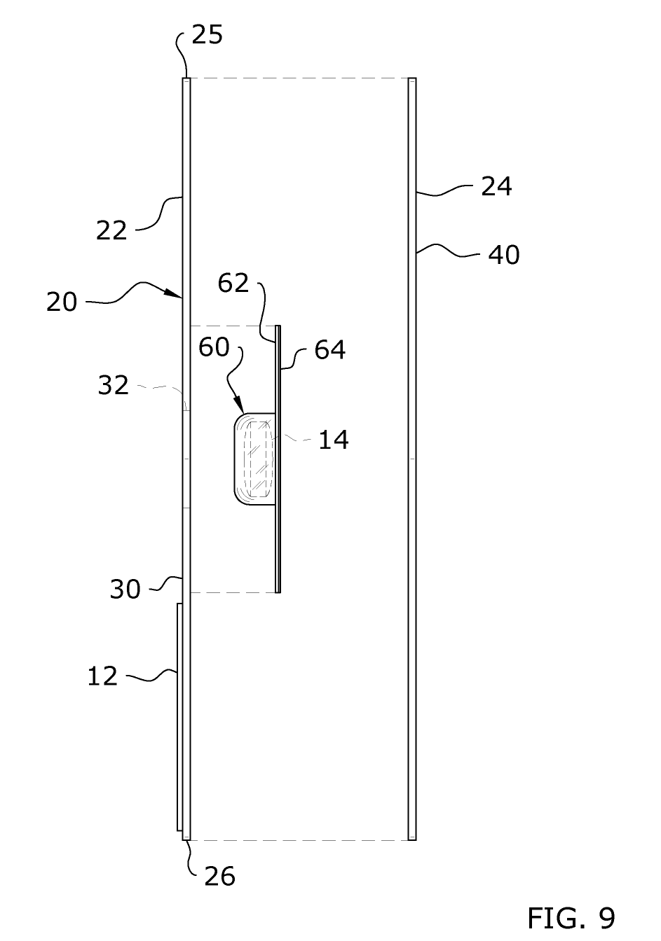

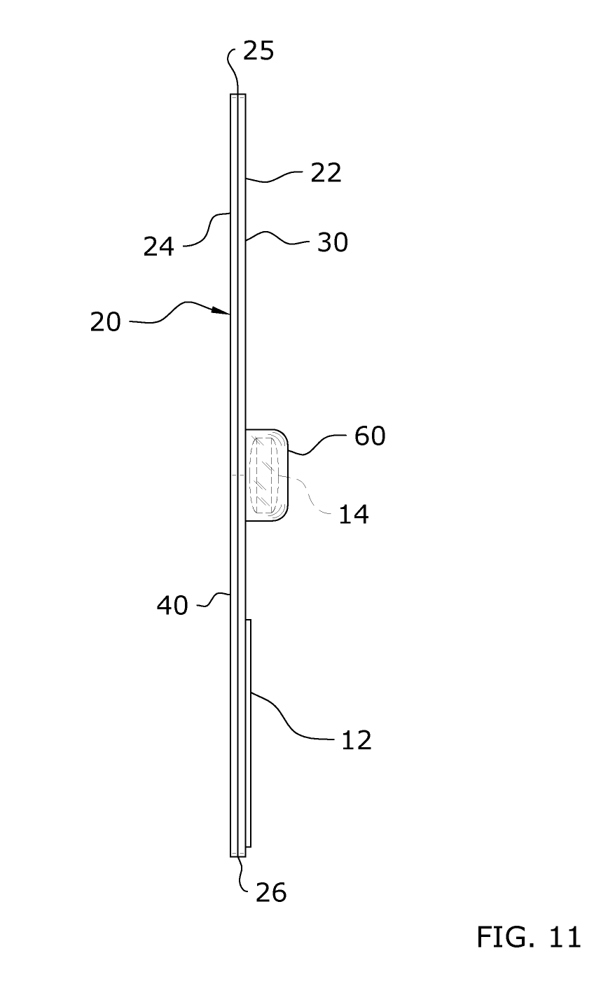

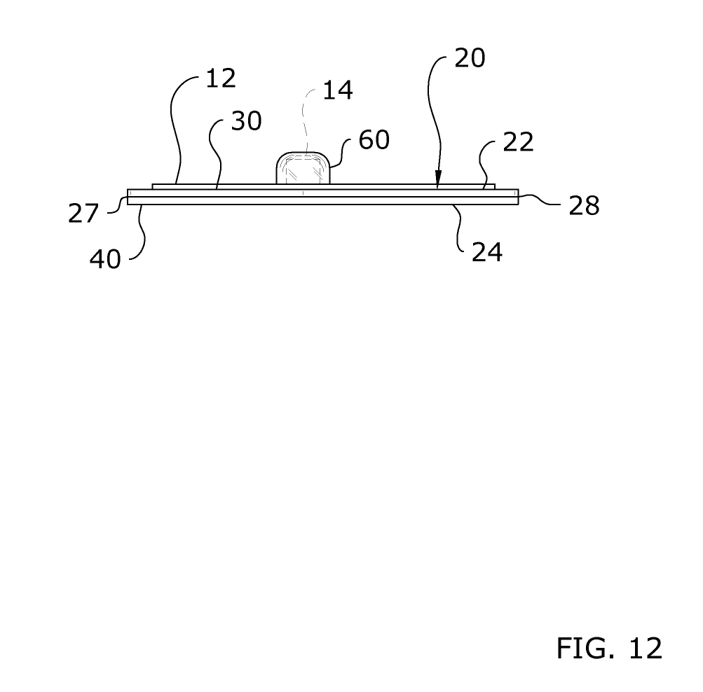

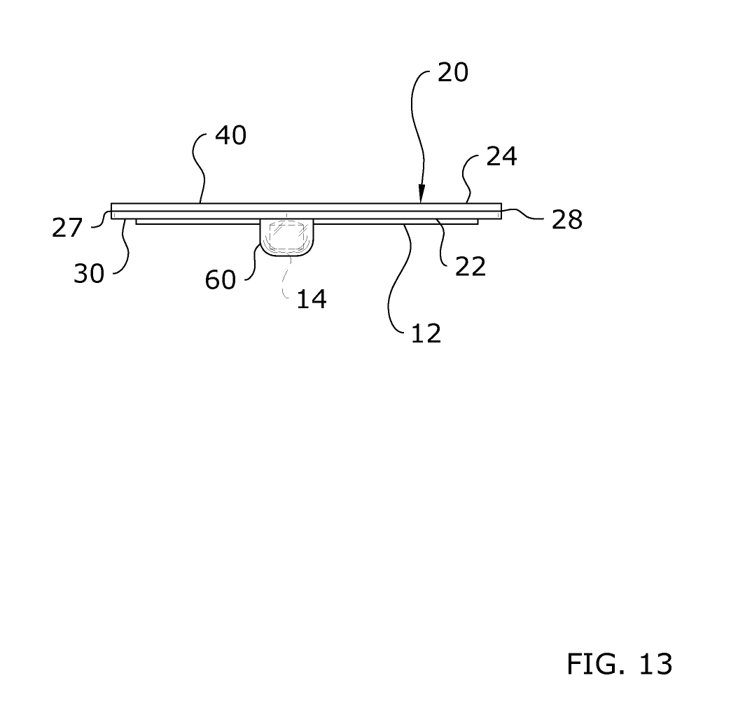

Turning now descriptively to the drawings, in which similar reference characters denote similar elements throughout the several views, FIGS. 1 through 13 illustrate a pharmaceutical packaging 10, which comprises a support member 20 having a pill area 54 for storing a pharmaceutical pill 14, a label area 50 for receiving a pharmaceutical label 12 and an information area 52 for providing information about the pharmaceutical pill 14. The label area 50 does not overlap the location of the pharmaceutical pill 14 within the support member 20 to allow for extraction of the pill without damaging of the pharmacy label 12.

The pharmaceutical packaging 10 is preferably comprised of a blister card or blister pack structure for storing and dispensing items such as but not limited to pharmaceutical pills 14. The pharmaceutical packaging 10 is preferably adapted to store and dispense a single pharmaceutical pill 14 as shown in the drawings. However, two or more pharmaceutical pills 14 may be stored within the pharmaceutical packaging 10. The pharmaceutical pill 14 may be comprised of various sizes and shapes (e.g. circular, elongated, rectangular, cylindrical). The pharmaceutical pill 14 may also be comprised of various structures capable of providing a pharmaceutical dosage to a user such as but not limited to tablets, caplets, capsules, lozenges, chewing gum, dissolving film, powder and the like. The pharmaceutical pill 14 is preferably comprised of any type of conventional solid pill for oral consumption by a user. However, the pharmaceutical pill 14 may also be comprised of a dispensing container (e.g. sprayer, drop dispenser) for dispensing a non-solid pharmaceutical product such as liquids, vapors and powders (e.g. drops, syrup, oral spray, ointment). For the purposes of this invention, the term “pharmaceutical pill 14” shall include all types of products (e.g. solid, liquid, vapor) that are to be consumed or applied to a user whether or not requiring a medical prescription.

### B. Support Member.

The pharmaceutical packaging 10 includes a support member 20 as illustrated in FIGS. 1 through 4 of the drawings. The support member 20 is preferably rigid or at least semi-rigid to support the pocket 60 and the pharmaceutical label 12 received from a doctor or pharmacist. The support member 20 may be comprised of various types of materials such as but not limited to paperboard and plastic.

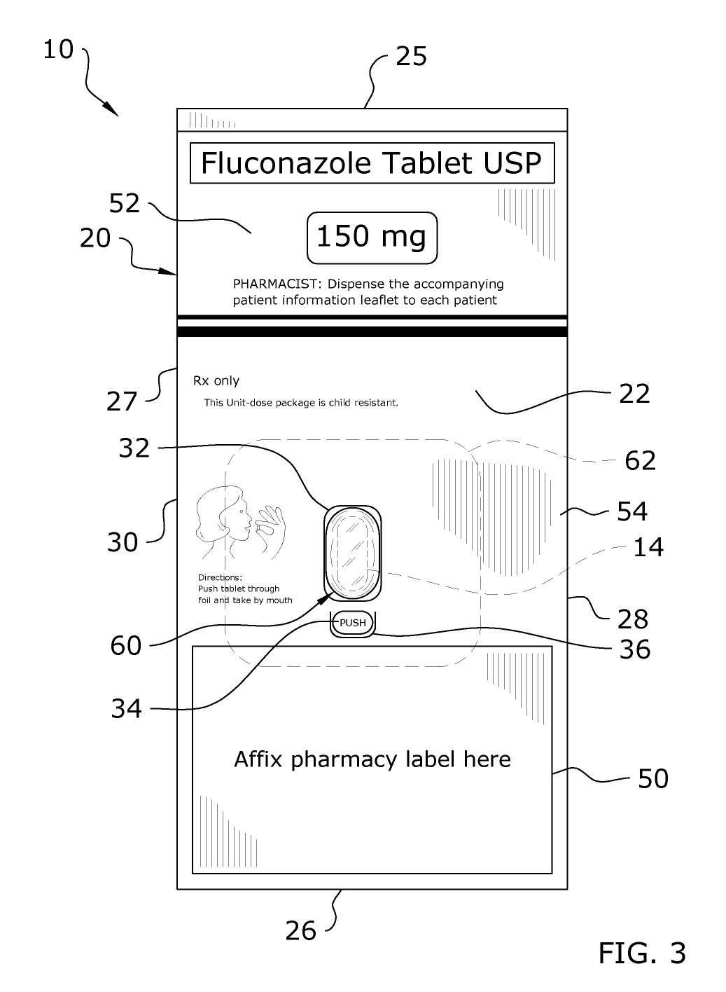

The support member 20 is preferably comprised of a planar structure having a front surface 22 and a rear surface 24. The support member 20 is further preferably comprised of a thin and flat structure as best illustrated in FIGS. 1, 6, 8a and 8b of the drawings. The support member 20 may have various shapes (e.g. square, rectangular, oval, circular, triangular), however, it is preferably for the present invention that the support member 20 be comprised of an elongated rectangular structure having a longitudinal axis extending from a bottom edge 26 to a top edge 25. FIGS. 3, 4 and 7a best illustrate the rectangular embodiment of the present invention showing the top edge 25, the bottom edge 26, the left edge 27 and the right edge 28 opposite of the left edge 27. It is preferable that the left edge 27 is parallel with respect to the right edge 28 and that the top edge 25 is parallel with respect to the bottom edge 26 as further illustrated in FIGS. 3, 4 and 7a of the drawings.

The support member 20 further is comprised of a lower portion, a central portion positioned above the lower portion and an upper portion positioned above the central portion. The lower portion, central portion and upper portion may or may not have the same shape and size. For example, the lower portion may be comprised of a larger area than the upper portion and vice versa.

The support member 20 may be comprised of a single layer or multiple layers. As illustrated in FIGS. 1, 2, 5, 6 and 8a through 13, the support member 20 is preferably comprised of a front layer 30 and a rear layer 40 attached to the front layer 30 using an adhesive or other attachment system. The front layer 30 and the rear layer 40 are preferably comprised of a paperboard material.

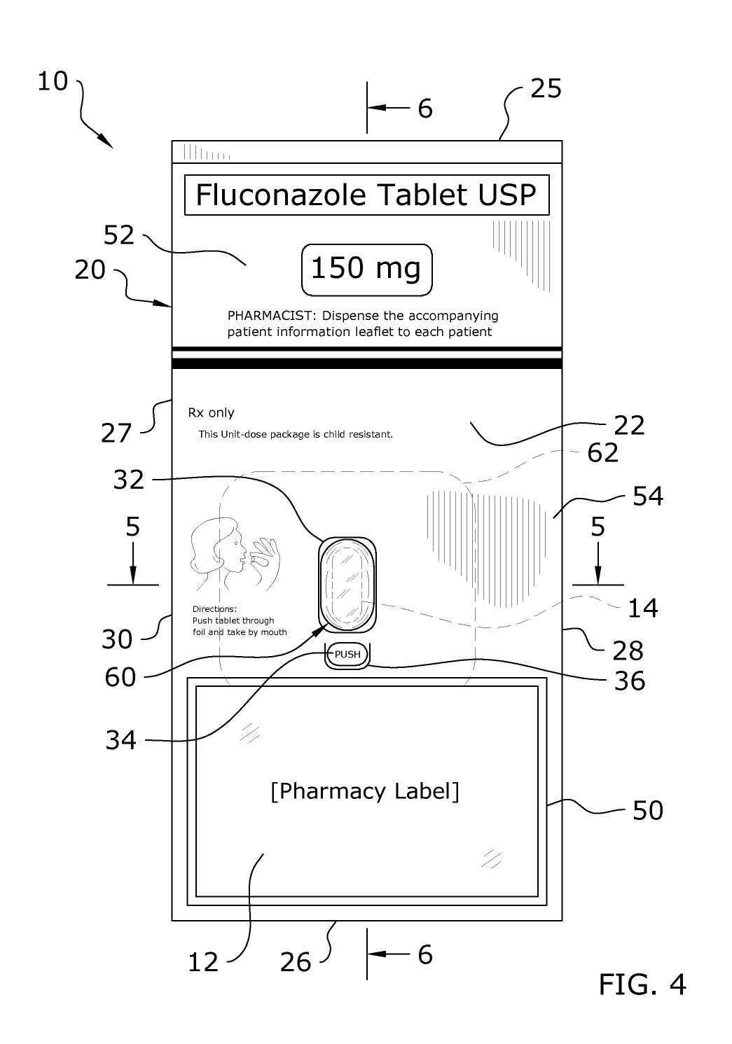

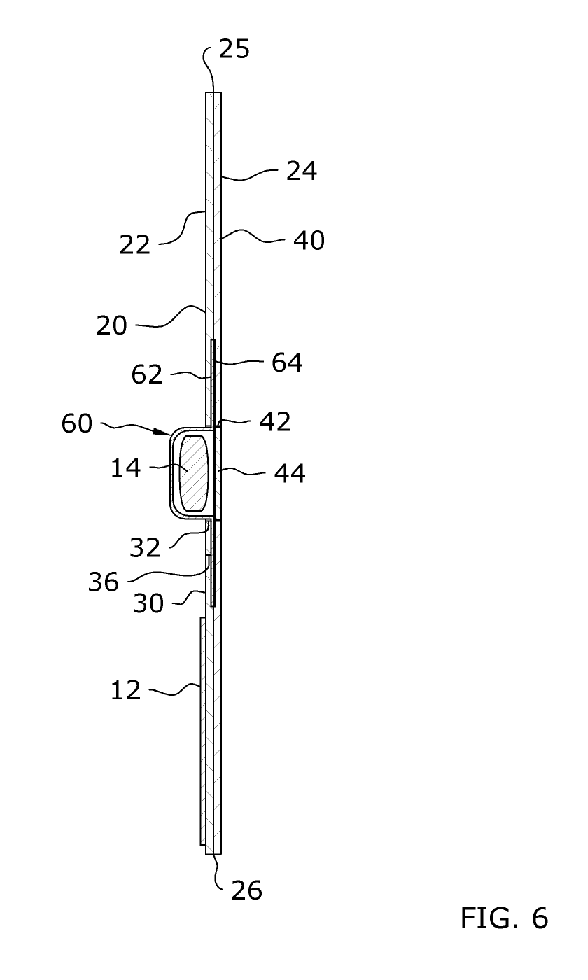

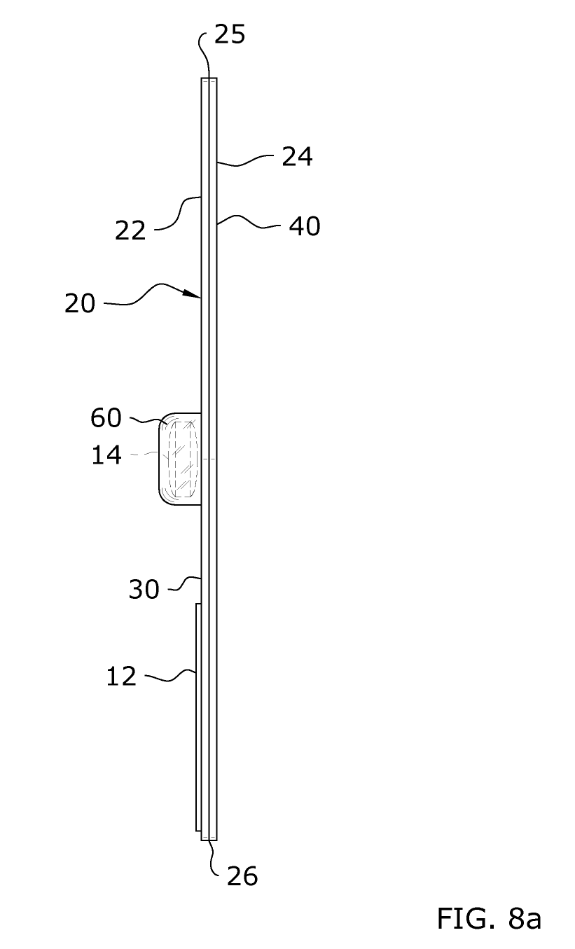

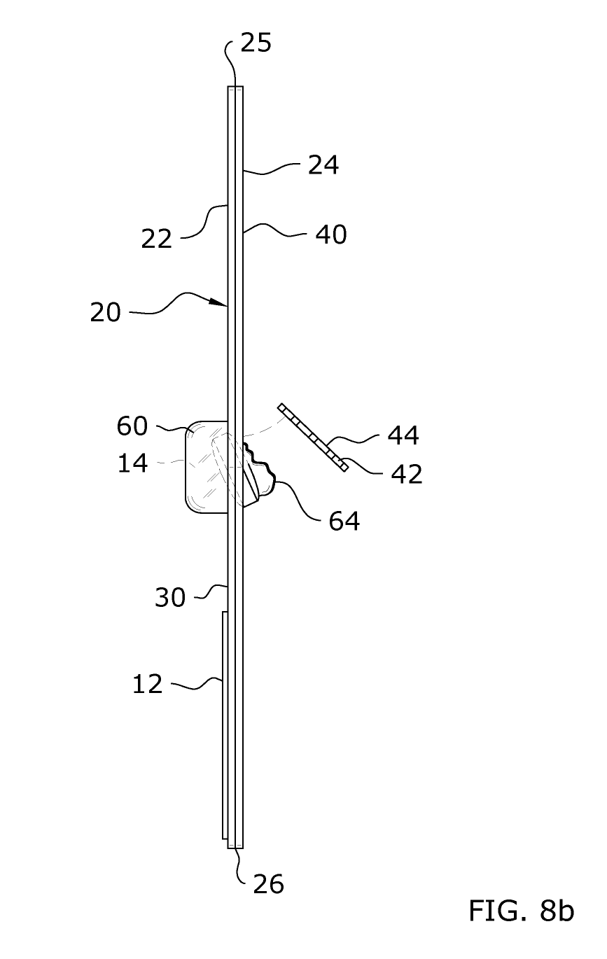

The front layer 30 includes a front opening 32 that the pocket 60 containing the pharmaceutical pill 14 extends through as best illustrated in FIGS. 3, 4 and 10 of the drawings. The front opening 32 has a shape similar to the shape of the pocket 60 and is larger than the pocket 60 as best illustrated in FIGS. 3 and 4 of the drawings. The pocket 60 extends outwardly from the front surface 22 through the front opening 32 thereby visually showing the pharmaceutical pill 14 to the user as illustrated in FIGS. 6, 8a and 8b of the drawings.

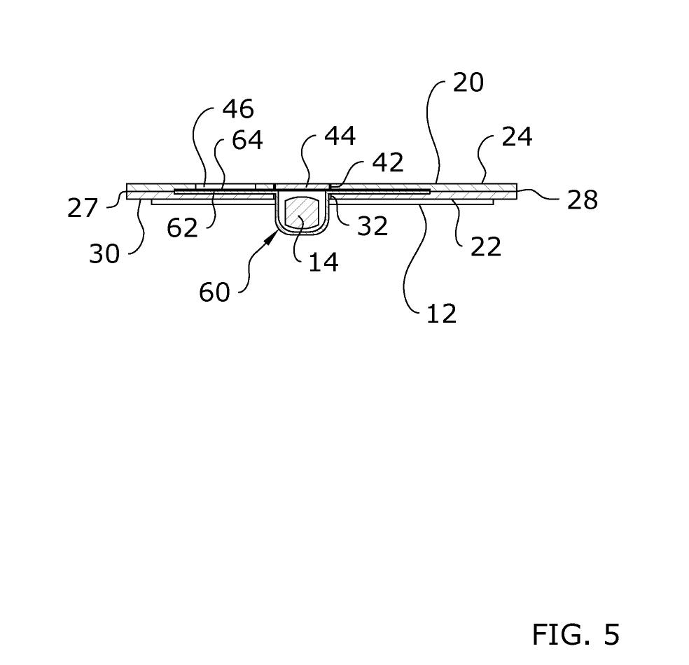

The front layer 30 is attached to the rear layer 40 with the flanged portion 62 of the pocket 60 positioned between the layers 30, 40 as best illustrated in FIGS. 5 and 6 of the drawings. The pocket 60 may be slightly movable or non-movable between the layers 30, 40. The layers 30, 40 retain the pocket 60 extending through the front opening 32 of the front layer 30. The front layer 30 further preferably includes a slit 36 having a U-shape positioned near the pocket 60 and front opening 32 to provide a visual indication for the user to push upon the pocket 60 to extract the pharmaceutical pill 14. A push indicia 34 (e.g. the word “PUSH”) along with a symbol (e.g. shaded or colored area) is positioned within a button portion formed by the U-shaped slit 36 as illustrated in FIG. 4 of the drawings.

The rear layer 40 includes a peel tab 44 aligned with the front opening 32 and with the pharmaceutical pill 14 along with the pocket 60 to allow for extraction of the pharmaceutical pill 14 from the pocket 60. The peel tab 44 is formed by a plurality of perforations 42 that allow for tearing and removal of the peel tab 44 from the support member 20. It can be appreciated that the peel tab 44 is not required and that the rear layer 40 may have an opening aligned with the pocket 60 to allow for extraction of the pharmaceutical pill 14 after perforating the backing 64 of the pocket 60. The rear layer 40 further includes a rear opening 46 that is aligned with printed information on the backing 64 of the pocket 60 (e.g. lot identifier and expiration date) which allows for viewing of the printed information on the backing 64 of the pocket 60.

### C. Label Area.

The support member 20 includes a label area 50 adapted for receiving a label having an adhesive back such as a pharmaceutical label 12. The label area 50 is preferably positioned in the lower portion of the support member 20 near the bottom edge 26 thereof as illustrated in FIGS. 1 through 4 of the drawings, however, the label area 50 may be positioned in the upper portion or central portion of the support member 20. The label area 50 may be positioned upon the rear surface 24 of the support member 20, but the label area 50 is preferably positioned upon the front surface 22 of the support member 20 to provide easy and convenient viewing of the attached pharmacy label 12 by the user.

The label area 50 does not overlap the pocket 60 thereby preventing interference with the display or extraction of the pharmaceutical pill 14 from the pocket 60. The label area 50 is may be a blank area without a defined border or the label area 50 may be defined at least partially by a border (e.g. a border line, colored section). The label area 50 may be defined by a line (e.g. solid line, dashed line, etc.) or colored section (e.g. the label area 50 is colored white with the remaining portion of the front surface 22 or rear surface 24 comprised of a different color).

It is preferable that the label area 50 be defined by a border identifying the entire label area 50 such as but not limited to a rectangle as illustrated in FIGS. 1 and 3 of the drawings. The rectangular border is preferably larger in size than a conventional pharmacy label 12 that is attached to the label area 50. The border defining the label area 50 is further spaced inwardly from the bottom edge 26, the left edge 27 and the right edge 28 a distance as illustrated in FIG. 3 of the drawings. The label area 50 further may include a printed message such as “Affix pharmacy label here” as further illustrated in FIGS. 1 and 3 of the drawings. The label area 50 is larger than the pharmacy label 12 such that to provide sufficient space for manual or automatic attachment of a label (e.g. a pharmacy label 12) to the label area 50 without overlapping any portion of the pocket 60 that surrounds the pharmaceutical pill 14 (there can be some overlapping of the label area 50 and the flanged portion 62 of the pocket 60 as illustrated in FIG. 4).

### D. Pill Area.

The support member 20 includes a pill area 54 adapted for storing and dispensing at least one pharmaceutical pill 14. The pill area 54 is preferably positioned within the central portion of the support member 20 above the label area 50 and below the information area 52. However, the pill area 54 may be positioned in the upper portion or the lower portion of the support member 20 as long as the label area 50 is positioned within a different area of the support member 20. The pill area 54 is preferably positioned between the label area 50 and the information area 52 within the front surface 22 of the support member 20 as illustrated in FIG. 4 of the drawings. The pill area 54 is preferably positioned between the label area 50 and the top edge 25 or the bottom edge 26 of the support member 20. The pill area 54 is adapted to receive and retain a blister pack structure that retains at least one pharmaceutical pill 14.

The pill area 54 is preferably positioned upon the front surface 22 of the support member 20 along with the label area 50 and/or the information area 52. It is preferable that the pill area 54, the label area 50 and the information area 52 are all positioned upon the same side of the support member 20.

The pill area 54 preferably includes a pocket 60 attached to the support member 20 as shown in FIGS. 1 through 6 of the drawings. The pocket 60 may be constructed of any conventional type of blister pack structure. The pocket 60 is adapted for storing and dispensing the pharmaceutical pill 14. The pocket 60 defines an interior cavity that is larger than the pharmaceutical pill 14 positioned within the interior cavity of the pocket 60 as illustrated in FIGS. 4 through 6. The pocket 60 is formed so that the portion of the pocket 60 that extends outwardly through the front opening 32 of the support member 20 is not engaged by the pharmacy label 12 when attached.

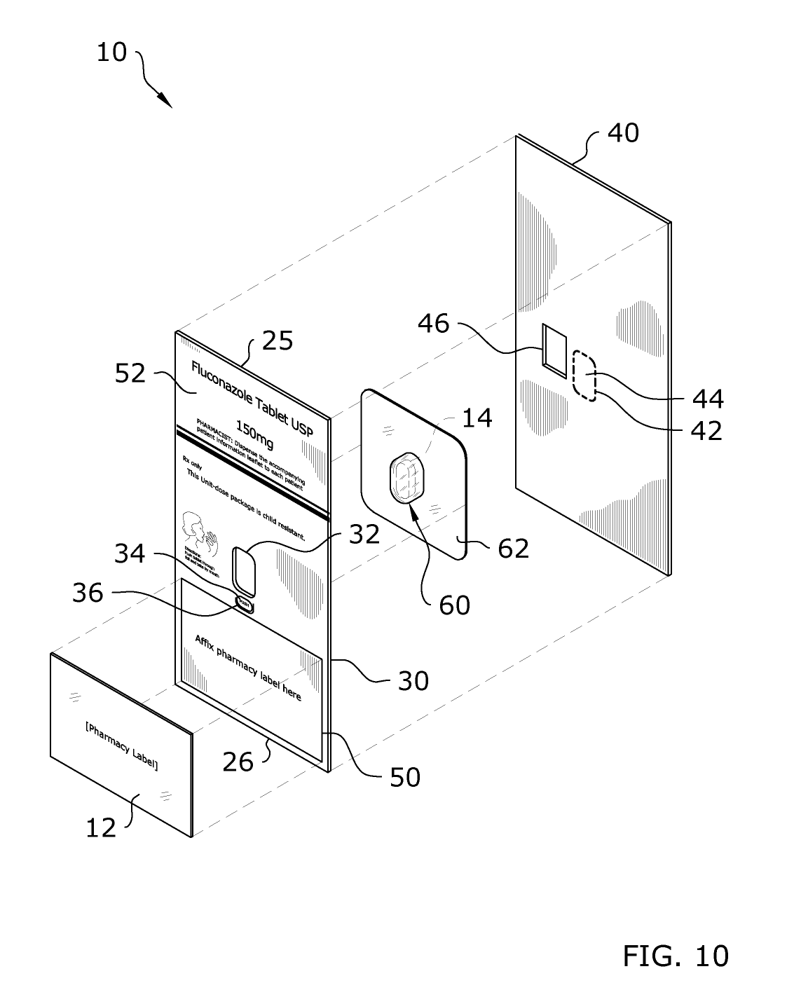

The pocket 60 is preferably comprised of a layer of plastic that defines the pocket 60 and a flanged portion 62 that extends outwardly from the pocket 60 as shown in FIG. 10 of the drawings. The flanged portion 62 is larger than the front opening 32 within the front layer 30 to retain the pocket 60 within the support member 20. A backing 64 is attached to the pocket 60 including the flanged portion 62 after the pharmaceutical pill 14 is positioned within the pocket 60 thereby retaining the pharmaceutical pill 14 within the pocket 60. Both the pocket 60 and the flanged portion 62 are preferably constructed of transparent or semi-transparent plastic material. The backing 64 is comprised of a breakable material and is preferably comprised of a layer of foil (e.g. aluminum foil, laminated aluminum foil) which is commonly used in blister packs.

The pocket 60 is preferably positioned above the label area 50 and the upper edge of the support member 20 as shown in FIGS. 1 through 4 of the drawings. The pocket 60 is preferably positioned between the label area 50 and an edge of the support member 20. In particular, the pocket 60 is preferably positioned between the label area 50 and the information area 52.

### E. Information Area.

The support member 20 includes an information area 52 adapted for providing printed information. The printed information in the information area 52 may be comprised of various types of information such as product identification for the pharmaceutical pill 14, information about the pharmaceutical pill 14, warning about the pharmaceutical pill 14, instructions for the pharmaceutical pill 14 and other information. The printed information may be text, graphics or any combination thereof. The printed information may be directly printed upon the support member 20 or applied to the support member 20 with a label or other attachment structure.

The information area 52 is preferably within the upper portion of the support member 20 above the central portion as shown in FIGS. 1 through 4 of the drawings. However, the information area 52 may be positioned within the lower portion or within the central portion of the support member 20.

### F. Operation of Preferred Embodiment.

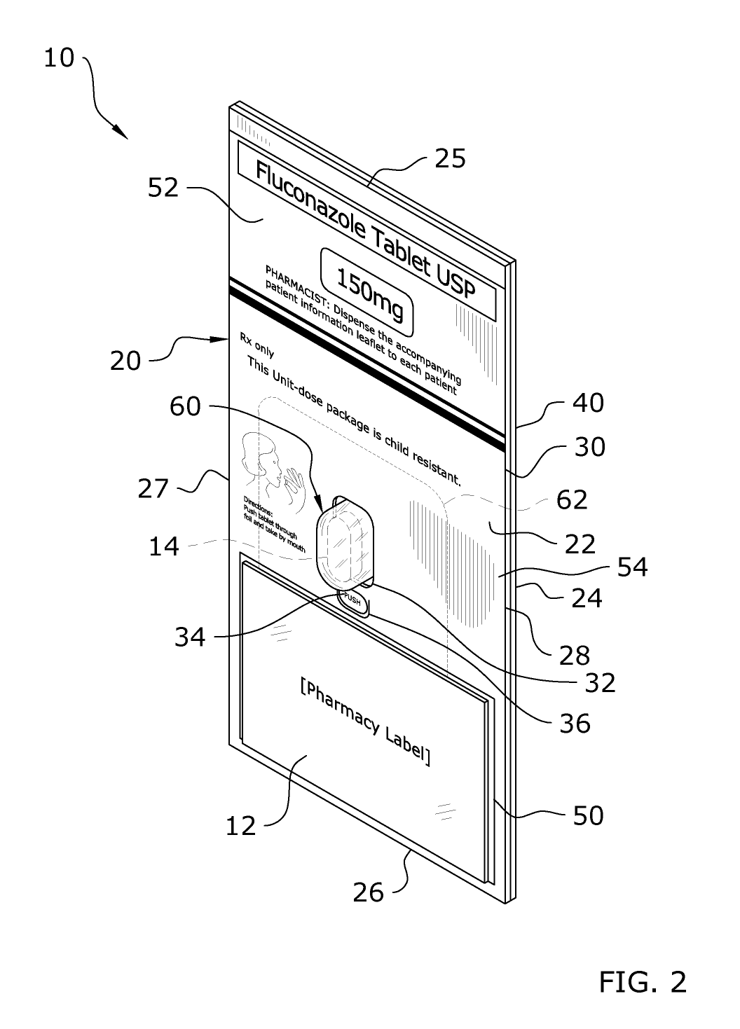

In use, the pharmaceutical pill 14 is packed within the pharmaceutical package 10 as illustrated in FIGS. 1 and 3 of the drawings. The pharmacy or doctor adhesively attaches a pharmacy label 12 to the label area 50 as illustrated in FIGS. 2 and 4 of the drawings and then provides the pharmaceutical package 10 to the user. It can be appreciated that the pharmacy label 12 may be attached utilizing a non-adhesive such as but not limited to stapling. The user views the pharmacy label 12 and is able to easily extract the pharmaceutical pill 14 by removing the peel tab 44 and then extracting the pharmaceutical pill 14 through the backing 64 of the pocket 60 by pushing upon the pocket 60 (constructed of a flexible plastic material that allows the pill to push through and pierce the backing 64). The user removes and consumes the pharmaceutical pill 14 as directed by the pharmacy label 12 and/or information area 52.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A pharmaceutical packaging, comprising:
a support member having a front surface and a rear surface;
wherein said support member includes a pill area adapted for storing a pharmaceutical pill, a label area adapted for receiving a pharmaceutical label and an information area adapted for providing printed information;
wherein said label area does not overlap said pill area.

2. The pharmaceutical packaging of claim 1, wherein said support member is comprised of a planar structure.

3. The pharmaceutical packaging of claim 2, wherein said support member is comprised of a rectangular shape.

4. The pharmaceutical packaging of claim 3, wherein said pill area is centrally positioned within said support member.

5. The pharmaceutical packaging of claim 3, wherein said pill area is positioned between said label area and said information area.

6. The pharmaceutical packaging of claim 3, wherein said support member includes a top edge, a bottom edge opposite of said top edge, a left edge, and a right edge opposite of said left edge.

7. The pharmaceutical packaging of claim 6, wherein said label area is closer to said bottom edge than said top edge.

8. The pharmaceutical packaging of claim 6, wherein said pill area is positioned between said label area and said top edge or said bottom edge.

9. The pharmaceutical packaging of claim 1, wherein said label area is defined at least partially by a border.

10. The pharmaceutical packaging of claim 1, wherein said label area is positioned upon said front surface.

11. A pharmaceutical packaging, comprising:
a support member having a front surface, a rear surface, a top edge and a bottom edge, wherein said support member includes a label area adapted for receiving a pharmaceutical label; and
a pocket attached to said support member, wherein said pocket is adapted for storing a pharmaceutical pill, wherein said pocket is positioned between said label area and an edge of said support member.

12. The pharmaceutical packaging of claim 11, wherein said support member is comprised of a planar structure.

13. The pharmaceutical packaging of claim 12, wherein said support member is comprised of a rectangular shape.

14. The pharmaceutical packaging of claim 13, wherein said pocket is centrally positioned within said support member.

15. The pharmaceutical packaging of claim 11, wherein said pocket is positioned between said label area and said upper edge of said support member.

16. The pharmaceutical packaging of claim 15, wherein said label area is positioned near said bottom edge of said support member.

17. The pharmaceutical packaging of claim 11, wherein said support member is comprised of paperboard and wherein said pocket is comprised of plastic.

18. The pharmaceutical packaging of claim 11, wherein said label area is defined at least partially by a border.

19. The pharmaceutical packaging of claim 11, wherein said label area is positioned upon said front surface of said support member.

20. A pharmaceutical packaging, comprising:
a support member having a rectangular shape and a planar structure, wherein said support member includes a front surface, a rear surface, a top edge and a bottom edge, wherein said support member includes a label area adapted for receiving a pharmaceutical label; and
a pocket attached to said support member, wherein said pocket is adapted for storing a pharmaceutical pill, wherein said pocket is positioned between said label area and an edge of said support member;
wherein said pocket is positioned between said label area and said upper edge of said support member;
wherein said label area is positioned near said bottom edge of said support member;
wherein said label area does not overlap said pocket;
wherein said label area is defined at least partially by a border;
wherein said label area is positioned upon said front surface of said support member.
